(19) United States
(12) Patent Application Publication
(10) Pub. No.: US 2010/0170499 A1
(43) Pub. Date: Jul. 8, 2010

(54) METHOD AND APPARATUS FOR EXTRACTING WATER FROM ATMOSPHERIC AIR AND UTILIZING THE SAME

(75) Inventor: Eitan Bar, Metar (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: EWA Tech Ltd., Metar (IL)

(21) Appl. No.: 12/376,836

(22) PCT Filed: Aug. 8, 2007
(86) PCT No.: PCT/IL07/00989

§ 371 Date: Feb. 9, 2009

Related U.S. Application Data
(60) Provisional application No. 60/836,282, filed on Aug. 8, 2006.
(60) Provisional application No. 60/849,678, filed on Oct. 4, 2006.

(51) Int. Cl. B01D 5/00; F25D 31/00; B23P 19/04; F24J 2/32; B01D 53/02

(52) U.S. Cl. 126/635; 62/271; 62/235.1; 29/700; 95/115; 96/146

(57) ABSTRACT

A new and unique apparatus for extracting water out of humid air is disclosed. There is also disclosed utilization of the apparatus and method in a specific and unique design so as to establish building blocks in building construction in order to cool indoor air in spaces in which the designated building blocks are combined.

### FIELD OF THE INVENTION

The present invention relates to method and technology of extracting air humidity in order to supply water. More particularly, the present invention relates to implementation of the method of extracting water from air humidity in hot and dry regions, where infrastructure for fresh water is not available or water supplement or quality is not secured. In addition, this invention also relates to method of integrating an apparatus for extraction water from air in constructions such as building blocks of buildings while utilizing, beside water supplement, temperature control and moisture control.

### BACKGROUND OF THE INVENTION

Water extraction from air moisture as an alternative water source is known and reported since bible time. Water from air humidity, an unlimited renewable natural resource, is available to all mankind, except in certain climatic extremes such as temperatures bellow 4° C. and extreme arid zone. One cubic kilometer of air routinely contains 10 to 40 tones of life-giving water. Nature continually recharges the atmosphere with moisture by evaporation from oceans, seas and fresh water bodies. Cost effective adsorption of atmospheric moisture and low dependency on ambient relative humidity and temperature are the breakthrough characteristics of effective method and technology enable utilization of this enormous water resource. Unfortunately, none of the existing methods and technologies to extract water from air overcomes these basic problems to fulfill these demands.

Various methods for extraction of atmospheric moisture for water supplement, as well as for air drying, are known and reported (for example: U.S. Pat. No. 1,816,592, U.S. Pat. No. 2,761,292, U.S. Pat. No. 3,740,959, U.S. Pat. No. 4,315,599, U.S. Pat. No. 4,351,651, U.S. Pat. No. 4,433,552, U.S. Pat. No. 4,726,817, U.S. Pat. No. 6,490,879, U.S. Pat. No. 6,644,060, DE 3,313,711, EP 1,142,835, WO 2004029372, U.S. Pat. No. 6,182,453, U.S. Pat. No. 2,779,172, U.S. Pat. No. 2,919,553, U.S. Pat. No. 2,944,404, U.S. Pat. No. 3,740,959, U.S. Pat. No. 4,315,599, U.S. Pat. No. 4,506,510, U.S. 20050103615). Technologies utilizing cold for condensation, whether by direct cooling the air, and thereby reducing moisture capacity of the air below dew point, or condensation on cold object enable condensation of humidity without cooling the entire air volume, were reported. However, cold-based methods suffer from few disadvantages and technical limitations, including the need to apply electric power, effective at high relative humidity and at moderate temperature range, adsorb air pollutions and contaminates with the humidity and high energy consumption. Moreover, due to the need to cool large volumes of air and the high energy consumption, such technologies are limited for small scale apparatii, while the bigger reported was with daily capacity of 1 to 2 cubic meters of water. Nevertheless, there is no doubt that under extremely high relative humidity (RH), cold condensation is highly effective and the lower energy consumed technology for air drying or for extraction of water from air, especially if natural energy of physical process such as solar energy or night cold are involves. For instance, patent application IL 183073, which is based on patent application 182120, describe a method for extraction water from air combining solar Infrared chilling, night chilling, wind-flow and natural termo isolation.

Different approach suggesting utilization of the dipolar property of the water molecule using electromagnetic technologies and charged electrode to capture humidity (U.S. Pat. No. 4,206,396). Additional approach claims condense humidity by applying pressure using compressor (U.S. Pat. No. 6,230,503, WO01/36885A1, U.S. Pat. No. 6,360,549, U.S. Pat. No. 6,453,684). Additional group of methods involves desiccating materials, including liquid or solid (for example U.S. Pat. No. 2,138,689, U.S. Pat. No. 2,462,952, U.S. Pat. No. 4,146,372, U.S. Pat. No. 4,185,969, U.S. Pat. No. 4,219,341, U.S. Pat. No. 4,285,702, U.S. Pat. No. 4,304,577, U.S. Pat. No. 4,342,569, U.S. Pat. No. 4,345,917, U.S. Pat. No. 4,374,655, FR 2,813,087, WO 09966136, US 20050103615, WO 106649, U.S. Pat. No. 6,588,225). In many of the technologies, solar heat is utilize to desorb the humidity adsorbed by the desiccants, while condensation is made by heat exchanging technique, mainly with cold air or water. The reason for the need to use natural energy source is the high energy required for desorption since water evaporation is required, consume more than 550 kcal per each liter of water and temperature close to 100 deg C. Under such conditions, additional energy is needed to condense the vapors to liquid. Therefore, with integration of, energy recovery techniques (U.S. Pat. No. 4,345,917) or without using waste or solar heat, the practical application of such technologies is in doubt.

In order to reduce energy consumption, in WO 09966136A1 it was suggested to integrate pressure-valve enabling desorption under low temperature of about 65 deg C. simultaneously with increasing the pressure in the condenser. This enables condensation without applying cooling.

### SUMMARY OF THE INVENTION

The present invention combines various technologies and methods in order to overcome the drawbacks of the known methods for extracting water from atmospheric air and to, enable fresh water production at reasonable energy consumption, low dependency on ambient relative humidity and temperature. The present invention is applicable under conditions that cannot be appropriate in the known methods and technologies.

The present invention makes it possible to extract water vapors from the atmospheric air in small and medium portable devices, as well as extremely large water plants, including portable devices.

There is therefore provided, in accordance with a preferred embodiment of the present invention, a method for extracting water from atmospheric air. The method comprises the steps of:

(a) causing ambient air to be drawn across an air-desiccation material that is adapted to adsorb and/or absorb water vapors;

(b) collecting heat formed of the adsorption process and utilizing it to cool the condenser during the absorption stage using heat pump technology.

(c) contributing energy to cool the condenser and thereby reduce temperature of ambient air pass through the condenser to achieve condensation of the humidity out of the atmospheric air passed. This can be performed by solar heat collector, or any alternative heat source, including waste or residual heat.

(d) flowing cold air formed in the condenser through gas-gas heat exchanger located at the inlet of the desiccant container in order to reduce the temperature of the atmospheric air entering into the desiccant container, and thereby increasing relative humidity and optimize the adsorption conditions and preventing evaporation of the absorbed humidity as a results of combination of dry air and high temperature.

(e) after the desiccant material has been fully or partially saturated with water vapor, sealing the desiccant container from enclosure of fresh air;

(f) circulating hot air in order to absorb water in the desiccant as vapor;

(g) diverging minor amount of the circulated air into the condenser, cooling it by heat energy contributed by the desorption process and solar heat and any alternative heat source, using heat pump technology.

(h) collecting condensed water.

(i) releasing the cooled air from the condenser, and entering atmospheric air into the desiccants container through one direction valve to compensate the volume air.

(j) after all the water previously accumulated in the desiccation material was released and steams are condensed, opening the desiccants container and flowing fresh atmospheric air through the desiccants container.

By designing the water production unit in flat and narrow dimensions, it is possible to combine a plurality of units together in a frame of wall or ceiling, while the external side of each unit is connected to solar heater and the internal side is exposed to the indoor space. In such design, it is also possible to cool indoor air directly with the cold condensation and/or to circulate the internal air through the condenser in order to remove humidity and to control indoor air temperature, including cooling the cold air by flowing it from the condenser or hot air by flowing it from the absorption/desorption compartment into the building space.

With such configuration, when the water production unit is designed in a compact structure having two sides wherein the absorption/desorption process occurs on one side while condensation occurs on the second side that involves cooling, it is an object of the present invention to provide a construction of walls or ceilings or any part of the building with building blocks that are capable of extracting humidity from atmospheric air, as an alternative source for fresh water supply. In parallel, the construction controls the internal temperature and humidity of close spaces.

It is another object of the present invention to integrate water producing system as a part of a construction with no need to make any significant change in the construction.

Before explaining at least one embodiment of the invention in detail, it is to be understood that the present invention is not limited in its application to the details set forth in the following description or exemplified by the examples. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which the invention belongs. In addition, the descriptions, materials, methods, and examples are illustrative only and not intended to be limiting. Methods and materials similar or equivalent to those described herein can be used in the practice or testing of the present invention.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The term “method” refers to manners, means, techniques and procedures for accomplishing a given task including, but not limited to, those manners, means, techniques and procedures either known to, or readily developed from known manners, means, techniques and procedures by practitioners of the chemical, of engineering, and technological arts. Implementation of the methods of the present invention involves performing or completing selected tasks or steps manually, automatically, or a combination thereof.

The phrase “consisting essentially of” means that the composition or method may include additional ingredients and/or steps, but only if the additional ingredients and/or steps do not materially alter the basic and novel characteristics of the claimed composition or method.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. Whenever a numerical range is indicated herein, it is meant to include any cited numeral (fractional or integral) within the indicated range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

As used herein, the singular form “a,” “an,” and “the” include plural references unless the context clearly dictates otherwise. For example, the term “a compound” or “at least.

It is thus provided in accordance with a preferred embodiment of the present invention, an improvement to a method of extracting water from atmospheric air that comprises a first stage in which atmospheric air is passed through a desiccant material and is absorbed so as to saturate the desiccant material with water vapor and a second stage in which dry and hot air is passed through the desiccant material so as to evaporate the water from the desiccant material and pass it through a condenser so as to collect the water that condenses on the condenser, the improvement comprising capturing heat formed by the desiccant material in the first stage and utilizing said heat to cool the condenser.

Furthermore and in accordance with a preferred embodiment of the present invention, said capturing heat formed by said desiccant material is combined with capturing solar heat.

Furthermore and in accordance with a preferred embodiment of the present invention, the improvement further comprising utilizing cold air released by the condenser during the first stage to reduce temperature and increase relative humidity of the atmospheric air passed through the desiccant material.

Furthermore and in accordance with a preferred embodiment of the present invention, the improvement further comprising recovering heat forming from cooling the condenser and combining said heat with solar heat so as to maintain high temperature in the second stage and thereby reducing heat consumption.

It is therefore also provided in accordance with another preferred embodiment of the present invention an improvement to an apparatus for extracting water from atmospheric air that comprises a container provided with a desiccant material adapted to adsorb water vapor and a condenser adapted to recover water from saturated air, the improvement comprising a heat collector adapted to collect heat and a heat pump adapted to receive said heat and utilizing said heat to cool the condenser.

Furthermore and in accordance with a preferred embodiment of the present invention, the improvement further comprising a solar heat collector that transfers additional heat to said heat pump.

Furthermore and in accordance with a preferred embodiment of the present invention, the improvement further comprising a heat exchanger adapted to utilize cold air released by the condenser in order to reduce the temperature and increase relative humidity of the atmospheric air that is passed through the desiccant material.

Furthermore and in accordance with a preferred embodiment of the present invention, the apparatus comprises at least one blower.

Furthermore and in accordance with a preferred embodiment of the present invention, the apparatus comprises a heating unit.

Therefore and in accordance with yet another preferred embodiment of the present invention, it is provided an integrated construction comprising:
a plurality of water extracting building blocks comprising a container provided with a desiccant material adapted to adsorb water vapor and a condenser adapted to recover water from air moisture;
a plurality of solar heat collectors wherein each solar collector is provided to each one of said water extracting building blocks wherein said solar collectors are adapted to utilize solar heat for either or both water release from said desiccant material and cooling said condenser;
water pipes adapted to transfer the extracted water for accumulation;
constructing material adapted to adhere said plurality of building blocks together.

Furthermore and in accordance with a preferred embodiment of the present invention, said plurality of water extracting building blocks are working in a continuous manner.

Furthermore and in accordance with a preferred embodiment of the present invention, said plurality of solar collectors are organized to be in an outer side of the construction while the condensers are organized to be placed in an inner side of the construction.

In addition and according to yet another preferred embodiment of the present invention, there of provided a method of integrating water extraction building blocks and air conditioning in a construction comprising:
providing a plurality of water extracting building blocks comprising a container provided with a desiccant material adapted to adsorb water vapor and a condenser adapted to recover water from saturated air;
structuring said plurality of water extracting building blocks in a wall-like structure;
providing water pipe to each one of said plurality of water extracting building blocks to collect the extracted water;
providing a plurality of solar collectors for utilizing solar heat for either or both water release from said desiccant material and cooling said condenser.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates an apparatus for extracting water, from atmospheric air in accordance with a preferred embodiment of the present invention.

FIG. 2 illustrates the apparatus shown in FIG. 1, during operation of the first stage in accordance with a preferred embodiment of the present invention.

FIG. 3 illustrates the apparatus shown in FIG. 1, during operation of the second stage in accordance with a preferred embodiment of the present invention.

FIG. 4 illustrates a building block of combined air extraction and air conditioning in accordance with a preferred embodiment of the present invention.

FIG. 5 illustrates the air flow during the absorption stage in a building block that is shown in FIG. 4 in accordance with a preferred embodiment of the present invention.

FIG. 6 illustrates the air flow during the desorption stage in a building block that is shown in FIG. 4 in accordance with a preferred embodiment of the present invention.

FIG. 7 illustrates a frontal view of a plurality of combined building blocks (view of the solar collectors) in accordance with a preferred embodiment of the present invention.

FIG. 8 illustrates a frontal view of the plurality of combined building blocks shown in FIG. 7, behind the solar collectors.

FIG. 9 illustrates a side cross sectional view of the combined building blocks shown in FIG. 7.

### DETAILED DESCRIPTION OF THE INVENTION

The present invention provides a new and unique apparatus for extracting water out of humid air and using an apparatus and method of as building blocks in buildings in order to cool indoor air in spaces in which the building blocks are combined.

According to one aspect of the present invention, it is provided an improvement to a method of extracting water from atmospheric air that comprises a first stage in which atmospheric air is passed through a desiccant material and is absorbed so as to saturate the desiccant material with water vapor and a second stage in which dry and hot air is passed through the desiccant material so as to evaporate the water from the desiccant material and pass it through a condenser so as to collect the water that condenses on the condenser. The improvement comprises capturing heat formed by the desiccant material in the first stage and utilizing this heat to cool the condenser. The method of the present invention succeeds in utilizing a method that is worthless from energy logistics reasons to a beneficial method that can be up scaled.

Reference is now made to FIG. 1 illustrating an apparatus for extracting water from atmospheric air in accordance with a preferred embodiment of the present invention. The apparatus comprises a desiccant container 1 provided with at least one cassette 4 containing dry desiccants material through which the air is passed. The desiccant material can be any conventional material adapted to absorb vapor water such as zeolite, silica gel, lithium salts, etc. A first desiccant container's damper 3 is provided to container 1 so as to allow air to be sucked into the container. The air is passed through an inlet heat exchanger 10 before it enters the container and cassette 4.

A main blower 2 that is positioned at an outlet tube of desiccants container 1 is adapted to suck the air into the container through heat exchanger 10. Alternatively, main blower 2 can be positioned at the inlet of desiccant container 1 so as to push the atmospheric air to within the container. The air that is passed through cassette 4 and main blower 2 is flowing through an air circulating container 6 and can be released through an air release damper 7 and a condenser damper 13. Air circulating container 6 is provided with an air heating unit 1 adapted to heat the air circulating in circulating container 6.

While air is passed through the desiccant material in cassette 4, heat is also absorbed and is being collected by heat collector 5 that is adapted to transfer the absorbed heat to a heat pump 8. Optionally, a solar heat collector 12 is provided and positioned at the inlet to heat exchanger 10. The energy supplied by both heat collector 5 and solar heat collector 12 is utilized by heat pump 8 as will be explained herein after.

The apparatus is further provided with a condensing plate 9. Atmospheric air that passes through plate 9 is condensed on the cool plate. The energy from the heat collectors, heat collector 5 and solar heat collector 12 can be used to cool water condensing plate 9. A secondary blower 15 is provided to the apparatus so as to pump the atmospheric air and allow it to pass through condensing plate 9. Water that is condensed on the plate can be released from the apparatus through a water outlet 14.

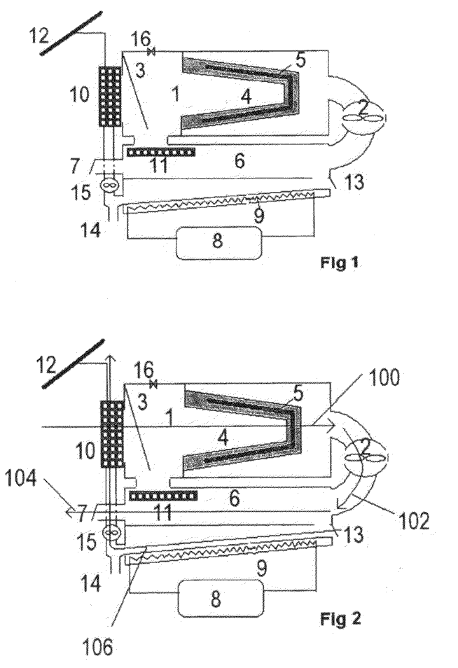

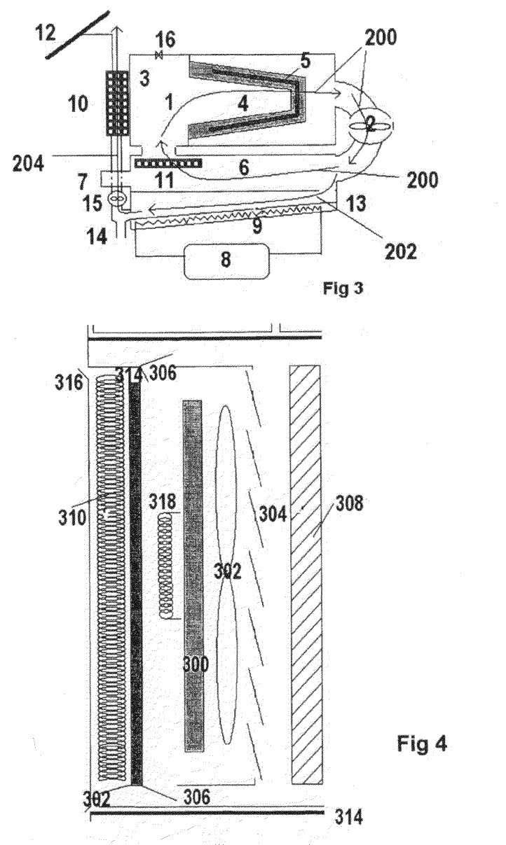

Reference is now made to FIGS. 2 and 3 illustrating the apparatus shown in FIG. 1, during operation of the first and second stages, respectively, in accordance with a preferred embodiment of the present invention.

According to the method of the present invention, the process of extracting water from atmospheric air is performed in two stages of operation. The first stage is the absorption process (shown in FIG. 2) in which main blower 2 is operated while dampers 3, 7 and 13 are open allowing air to flow through the apparatus entering through inlet heat exchanger 10 that is adjacent to desiccant container damper 3 wherein the air flow is marked using arrow 100. The atmospheric air passes through desiccant cassette 4 and through air circulating container 6 and is being released through damper 7. As mentioned herein before, the atmospheric air is being sucked into the apparatus by blower 2, the air is shown to pass through the blower by arrow 102 and the air that flows outwardly through damper 7 is marked by arrow 104. Heat exchanger 10 is adapted to reduce the temperature of the atmospheric air so as to increase the air's relative humidity before it enters cassette 4, where the water is absorbed. At the same time, atmospheric air (which flow is illustrated by arrow 106) that enters condenser plate 9 through damper 13 is cooled upon getting in contact with the condensing plate. The resulting cold air flows through blower 15 and into the inlet of heat exchanger 10 and is release to the atmosphere. Fresh atmospheric air enters inlet heat exchanger 10 in the other direction (arrow 100) and flows into the desiccants container 1. As mentioned, the atmospheric air passes through desiccant container 1 and through cassette 4 where the humidity is absorbed in the desiccant material and the generated heat is transferred to heat pump 8.

The first stage is completed when the desiccation material is saturated with the humidity of the atmospheric air. Then, the second stage of extracting the water is commencing.

In the second stage shown in FIG. 3, dampers 3, 7 and 13 are closed and blower 15 is turned off. The captured air in the desiccants container is circulated while air heating unit 11 is heating the circulated air; the air flow is indicated by arrows 200. Water condensing plate 9 is cooled by heat pump 8 or an independent gas compressor (the gas compressor is not shown in FIG. 1), while heat released from cold generation is being utilized to heat up or maintain heat in desiccants container 1.

When the temperature in desiccants container 1 reaches at least 65° C. the absorbed water in the desiccant material is evaporated as a results of the hot air flowing through.

When the temperature of condensing plate 9 reaches a temperature that enable condensation, or less, secondary blower 15 is being operated again so as to allow a small part of the circulated air (indicated by arrow 202) that is saturated with humidity to diverge into the condenser, so as to condense the moisture on condensing plate 9. The residual air that was passed through the condenser flows through heat exchanger 10 into the atmosphere; the air flow is indicated by arrow 204. In order to prevent vacuum in the apparatus, a one-direction valve 16 enables atmospheric air to be sucked into desiccants container 1. The water is collected from the system through water outlet 14.

When most of the absorbed water is extracted and condensed, the heating of the air by heating unit 11 stops and the system returns to the first absorption stage.

It should be mentioned that the apparatus for extracting water from atmospheric air that is applicable to the method of the present invention is an apparatus that is continuously operated.

It should be noted that the absorption conditions could be optimized in order to maximize the effectiveness of the method. As an example, as much as the ambient temperature is higher or sun irradiation is higher, more solar energy is supplied to heat pump 8, enabling massive reduction of the temperature of the air that passes through the condenser and flows into the inlet heat exchanger 10. In this way, atmospheric air that passes through heat exchanger 10 into desiccant container 1 is getting colder.

The energy loss from the desorption process according to the present invention is minimized by releasing the cooled air after condensation and recovering the heat formed in the condenser to maintain heat of desorption.

Moreover, minimizing absorption-desorption cycle by optimization of absorption conditions and condensation using cooled condenser is used in the apparatus of the present invention to increase the daily capacity of the apparatus.

According to another aspect of the present invention, it provides a method of combining the extraction of water from atmospheric air and air conditioning. According to the method of the present invention, the method comprises a plurality of modular building blocks in which the extraction of water occurs and is further comprising a construction made by the plurality of modular building blocks in order to establish an integrated working unit, structured in a wall, or any other part of buildings or construction.

The method is comprised of the following steps that takes place in each building block:

(a) causing ambient air to be drawn across an air-desiccation material that is adapted to adsorb and/or absorb water vapors;

(b) cooling a condenser to temperature bellow dew point and flowing indoor air through the cold Condenser to cool indoor atmosphere and to condensate the indoor humidity for water production;

(c) isolating the desiccants after it is saturated from the external atmosphere, and heating the desiccants by solar heat or any other heating source, including waste or residual heat, with or without involvement of heat pump;

(d) directing small air volume from the desiccants through the condenser into the internal space when the temperature of the desiccants is about 60 deg C. or higher and the temperature of the condenser is bellow dew point;

(h) collecting condensed water;

(j) opening the desiccants compartment after the water previously accumulated in the desiccants was released and condensed and allowing fresh atmospheric air to flow through the desiccants container.

Now, the building blocks are being integrated together to a combined wall-like structure:
(a) if more than two blocks are used, for optimal energy operating conditions, at any given moment, two third of the blocks are at the absorption stage and one third are at desorption stage, or any other ratio that provide highly energy and water production efficiency.
(b) all solar collectors are jointly connected and heat distribution between blocks is centrally controlled, while the solar heat flows from the solar collectors into the blocks that are in desorption stage, directly or through heat pump.
(c) the heat pump is also connected to central heat source that provides complementary heating that is utilized for the desorption process and provides energy to cool the condensers.
(d) water from all blocks is collected into central container.

Reference is now made to FIG. 4 illustrating a building block of combined air extraction and air conditioning in accordance with a preferred embodiment of the present invention. Each building block of the combined apparatus comprises desiccants cassette 300 adapted to absorb the humidity from air that is forced to pass through the cassette. Cassette 300 contains desiccants material through which the air passes. The desiccant material can be any conventional material, solid or liquid, adapted to absorb vapor water such as zeolite, silica gel, lithium salts, etc. A main blower 302 is adapted to move the air through cassette 300. Outdoor dampers 304 are provided adjacent to main blower 302 and an outlet damper 306 is also provided.

A solar heat collector 308 is provided adjacent outdoor dampers 304 while a condenser 310 that is adapted to allow condensation of water is provided on opposite to solar heat collector 308. A condenser blower 312 is adapted to move the air so it will pass through condenser 310.

Extracted water drains through a water outlet 314. An indoor damper 316 is provided in its vicinity while a heater or heat exchanger is adjacent to cassette 300.

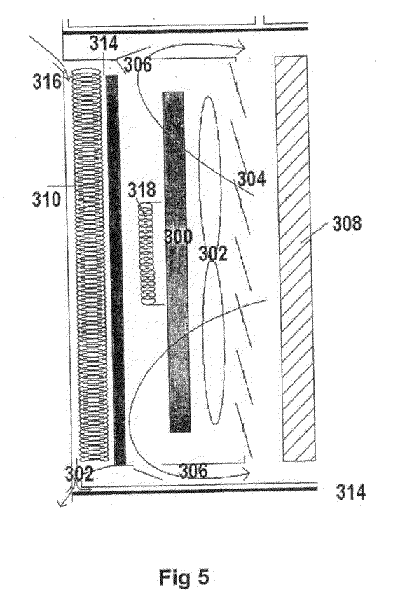

Reference is now made to FIG. 5 illustrating the air flow during the absorption stage in a building block that is shown in FIG. 4 in accordance with a preferred embodiment of the present invention. During the absorption stage, all dampers; outdoor dampers 304, outlet dampers 306, and indoor damper 316 are open. Blower 302 is operated and sucks atmospheric air from outdoor dampers 304 into cassette 300. The air is then released through outlet damper 306 back to the atmosphere. In case the outdoor temperature is lower than 4 deg C. or higher than about 45 deg C. or the outdoor relative humidity is extremely low or the indoor humidity is high, indoor damper 316 is also open.

The heat collected by solar heat collector 308 is utilized to cool condenser 310 using heat-pump technology. When the building block is in the absorption stage, the cold condenser, cooled by a heat-pump or electricity is used to cool the indoor atmosphere while indoor humidity that is condensed is released through water outlet (314) into a central water container (the container is not shown in the figure).

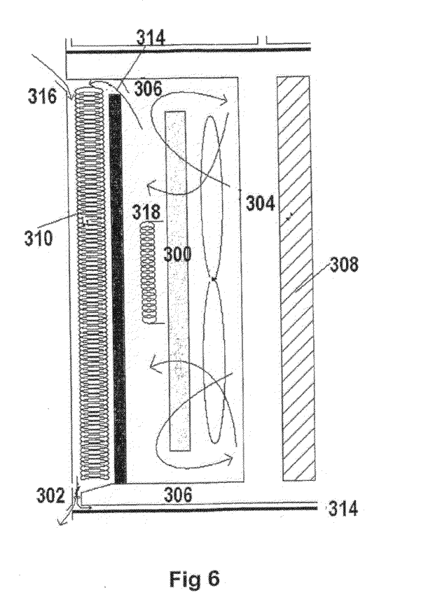

Reference is now made to FIG. 6 illustrating the air flow during the desorption stage in a building block that is shown in FIG. 4 in accordance with a preferred embodiment of the present invention. When desiccants in cassette 300 are saturated, dampers 304 and 406 are closed. The captured air in the building block is circulated through the desiccation cassette, and air heating unit 318 is heating the circulated air. Condenser 310 is cooled by heat pump or gas compressor, while heat is released upon cold generation might be utilized in order to heat up or maintain heat of the circulating air. When the temperature of the desiccants cassette is at least 65 deg C. and the condenser temperature is below dew point, small parts of the circulated air is diverged into the condenser to condense the moisture on condenser 310, and the cold air is released indoor. Atmospheric or indoor air might be mixed with the hot air before entering into the condenser to reduce temperature and save energy. When most of the absorbed water is extracted from the desiccants cassette and condensed, heating is stopped and the system returns to the absorption step.

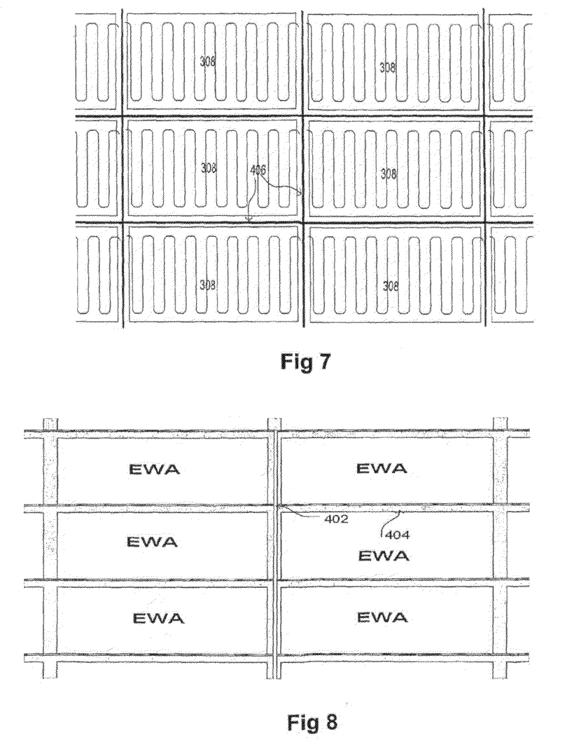

Reference is now made to FIG. 7 illustrating a frontal view of a plurality of combined building blocks (view of the solar collectors) in accordance with a preferred embodiment of the present invention. As mentioned herein before, the building blocks can be combined together in order to establish a wall-type structure. FIG. 7 depicts a plurality of building blocks such as the one that is shown in FIG. 4 that works together as a unit for extracting water and air conditioning. The front side of the wall shown in FIG. 7 is provided with solar heat collectors 308. The extracted water is being discharged from each building block and is collected through a system of hot water pipes 400.

Reference is now made to FIG. 7 illustrating a frontal view of the plurality of combined building blocks shown in FIG. 6, behind the solar collectors. EWA stands for a building block or a unit for extraction water from air. A water collection pipe system 402 is shown between the blocks as well as an interface concrete 404 that is provided between the blocks in order to unify the structure.

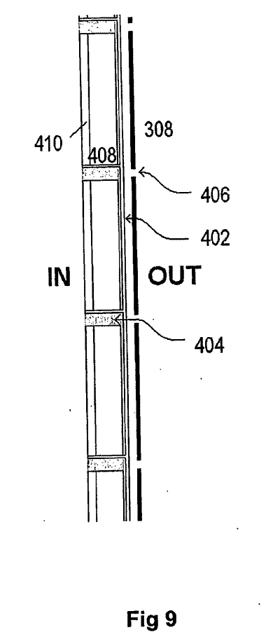

Reference is now made to FIG. 9 illustrating a side cross sectional view of the combined building blocks shown in FIG. 7. Solar collector 5 of each building block is seen on one side of the construction wherein the collectors are being formed as a layer. Free space 406 is provided between the solar collectors in order to allow atmospheric air to enter the building blocks. Condensers 310 are placed on the opposite side of the construction while between both sides, a compartment for absorption/desorption 408 is provided. Water collection pipe system 402 is transferring the water extracted in each of the building blocks to a certain container or an accumulator.

The building blocks are being connected to one another in a manner that is similar to regular building blocks construction. Interface concrete 404 is being placed between the units.

At any moment, for optimal energy consumption and water production, about two thirds of the building blocks are in the absorption stage while about one third are in the desorption stage. This ratio might be changed based on the desiccants characters and ambient relative humidity and temperature, without limiting the scope of the present invention. All solar collectors are jointly connected, and contribute heat to one third of the building blocks that are in the desorption stage. When all the absorbed water from the blocks that are in the desorption stage is extracted, outlet dampers 306 are opened and the next third of the blocks are returning to the desorption stage. The solar collectors are also connected to heat pumps that is being connected to alternative heat source, such as electric, gas, diesel or residual heat. The heat pump supply complementary heat, if necessary (such as at night time or in cloudy weather), for desorption, as well as energy to cool the condensers.

It should be clear that the description of the embodiments and attached Figures set forth in this specification serves only for a better understanding of the invention, without limiting its, scope as covered by the following Claims.

It should also be clear that a person skilled in the art, after reading the present specification can make adjustments or amendments to the attached Figures and above described embodiments that would still be covered by the following Claims.

1. An improvement to a method of extracting water from atmospheric air that comprises a first stage in which atmospheric air is passed through a desiccant material and is adsorbed so as to saturate the desiccant material with water vapor and a second stage in which dry and hot air is passed through the desiccant material so as to evaporate the water from the desiccant material and pass it through a condenser so as to collect the water that condenses on the condenser, the improvement comprising capturing heat formed by the desiccant material in the first stage and utilizing said heat to cool the condenser.

2. The improvement as claimed in claim 1, wherein said capturing heat formed by said desiccant material is combined with capturing solar heat.

3. The improvement as claimed in claim 1, further comprising utilizing cold air released by the condenser to reduce temperature and increase relative humidity of the atmospheric air passed through the desiccant material.

4. The improvement as claimed in claim 1, further comprising recovering heat forming from cooling the condenser and combining said heat with solar heat so as to maintain high temperature in the second stage and thereby reducing heat consumption.

5. An improvement to an apparatus for extracting water from atmospheric air that comprises a container provided with a desiccant material adapted to adsorb water vapor and a condenser adapted to recover water from saturated air, the improvement comprising a heat collector adapted to collect heat and a heat pump adapted to receive said heat and utilizing said heat to cool the condenser.

6. The improvement as claimed in claim 5, further comprising a solar heat collector that transfers additional heat to said heat pump.

7. The improvement as claimed in claim 5, further comprising a heat exchanger adapted to utilize cold air released by the condenser in order to reduce the temperature and increase relative humidity of the atmospheric air that is passed through the desiccant material.

8. The improvement as claimed in claim 5, wherein the apparatus comprises at least one blower.

9. The improvement as claimed in claim 5, wherein the apparatus comprises a heating unit.

10. An integrated construction comprising a plurality of improved apparatii for extracting water from atmospheric air as claimed in claim 5, adhered together and having a common water pipe for collecting accumulated water from said plurality of apparatii wherein each apparatus is provided with a solar collector.

11. An integrated construction comprising:
a plurality of water extracting building blocks comprising a container provided with a desiccant material adapted to adsorb water vapor and a condenser adapted to recover water from air moisture;
a plurality of solar collectors wherein each solar collector is provided to each one of said water extracting building blocks wherein said solar collectors are adapted to utilize solar heat for either or both water release from said desiccant material and cooling said condenser;
water pipes adapted to transfer the extracted water for accumulation;
constructing material adapted to adhere said plurality of building blocks together.

12. The integrated construction as claimed in claim 11, wherein said plurality of water extracting building blocks are working in a continuous manner.

13. The integrated construction as claimed in claim 11, wherein said plurality of solar collectors are organized to be in an outer side of the construction while the condensers are organized to be placed in an inner side of the construction.

14. A method of integrating water extraction building blocks and air conditioning in a construction comprising:
providing a plurality of water extracting building blocks comprising a container provided with a desiccant material adapted to adsorb water vapor and a condenser adapted to recover water from saturated air;
structuring said plurality of water extracting building blocks in a wall-like structure;
providing water pipe to each one of said plurality of water extracting building blocks to collect the extracted water;
providing a plurality of solar collectors for utilizing solar heat for either or both water release from said desiccant material and cooling said condenser.

15. An apparatus for extracting water from atmospheric air substantially as described in the above specification, attached Figures and appending claims.

16. A method for extracting water from atmospheric air substantially as described in the above specification, attached Figures and appending claims.

17. An integrated construction substantially as described in the above specification, attached Figures and appending claims.

18. A method, of integrating water extraction building blocks and air conditioning in a construction substantially as described in the above specification, attached Figures and appending claims.
